(19) United States
(12) Patent Application Publication
(10) Pub. No.: US 2026/0246279 A1
(43) Pub. Date: Aug. 20, 2026

(54) POWER MANAGEMENT APPARATUS, POWER MANAGEMENT METHOD, AND PROGRAM

(71) Applicant: KYOCERA CORPORATION, Kyoto (JP)

(72) Inventors: Nodoka NAKAGAKI, Kyoto (JP); Kenta KINOSHITA, Kyoto (JP)

(21) Appl. No.: 18/870,394

(22) PCT Filed: May 12, 2023
(86) PCT No.: PCT/JP2023/018010

§ 371 Date: Nov. 28, 2024

(30) Foreign Application Priority Data
May 30, 2022 (JP) 2022-087542

(51) Int. Cl. H02J 3/38; H02J 3/28

(52) U.S. Cl. CPC H02J 3/38; H02J 3/28

(57) ABSTRACT

A power management apparatus includes: a manager configured to manage two or more facilities connected to a power system; and a controller configured to control a distributed power supply installed in each of the two or more facilities in which the controller applies first control to a first distributed power supply installed in a first facility group including one or more facilities in which reverse power flow to the power system is allowed and the reverse power flow is not assumed, and the controller applies second control to a second distributed power supply installed in a second facility group including one or more facilities in which the reverse power flow is allowed and the reverse power flow is assumed.

### RELATED APPLICATIONS

The present application is a National Phase of International Application Number PCT/JP 2023/018010 filed May 12, 2023, which claims the benefit of priority from Japanese Patent Application No. 2022-087542, filed on May 30, 2022.

### TECHNICAL FIELD

The present disclosure relates to a power management apparatus, a power management method, and a program.

### BACKGROUND OF INVENTION

In recent years, a technology in which a power storage apparatus is used as a distributed power supply in order to maintain a power supply-demand balance of a power system (for example, a virtual power plant (VPP)) is known. In the VPP, the power storage apparatus is controlled by a power management apparatus that manages two or more facilities having the power storage apparatus.

Examples of methods of controlling the distributed power supply by the VPP includes load-following control for controlling the output power of the distributed power supply to follow the power consumption of a load, and sequential control for controlling the output power of the distributed power supply sequentially from the power management apparatus. The power management apparatus adjusts the power supply-demand balance of the power system in combination of the load-following control and the sequential control.

Further, a technology of classifying two or more facilities into two or more groups, and controlling, for each of the two or more groups, the distributed power supply of a facility that belongs to each of the two or more groups is proposed. For example, the groups are set by a distribution transformer (bank) (for example, Patent Document 1).

### CITATION LIST

### Patent Literature

Patent Document 1: JP 2019-68707 A

### SUMMARY

### Technical Problem

One aspect of the disclosure provides a power management apparatus including: a manager configured to manage two or more facilities connected to a power system; and a controller configured to control a distributed power supply installed in each of the two or more facilities in which the controller applies first control to a first distributed power supply installed in a first facility group including one or more facilities in which reverse power flow to the power system is allowed and the reverse power flow is not assumed, and the controller applies second control to a second distributed power supply installed in a second facility group including one or more facilities in which the reverse power flow is allowed and the reverse power flow is assumed.

One aspect of the disclosure provides a power management method including the step A of managing two or more facilities connected to a power system; and the step B of controlling a distributed power supply installed in each of the two or more facilities, wherein the step B includes the steps of: applying first control to a first distributed power supply installed in a first facility group including one or more facilities in which reverse power flow to the power system is allowed and the reverse power flow is not assumed; and applying second control to a second distributed power supply installed in a second facility group including one or more facilities in which the reverse power flow is allowed and the reverse power flow is assumed.

One aspect of the disclosure provides a program that causes a computer to perform: managing two or more facilities connected to a power system; and controlling a distributed power supply installed in each of the two or more facilities, wherein the controlling includes: applying first control to a first distributed power supply installed in a first facility group including one or more facilities in which reverse power flow to the power system is allowed and the reverse power flow is not assumed; and applying second control to a second distributed power supply installed in a second facility group including one or more facilities in which the reverse power flow is allowed and the reverse power flow is assumed.

### BRIEF DESCRIPTION OF THE DRAWINGS

FIG. 1 is a diagram illustrating a power management system 1 according to an embodiment.

FIG. 2 is a diagram illustrating a facility 100 according to an embodiment.

FIG. 3 is a diagram illustrating a lower management server 200 according to an embodiment.

FIG. 4 is a diagram illustrating a higher management server 300 according to an embodiment.

FIG. 5 is a diagram for describing classification of facilities according to an embodiment.

FIG. 6 is a diagram illustrating a power management method according to an embodiment.

FIG. 7 is a diagram illustrating a power management method according to an embodiment.

FIG. 8 is a diagram for describing a problem according to a first variation.

FIG. 9 is a diagram for describing a problem according to the first variation.

FIG. 10 is a diagram for describing a problem according to the first variation.

FIG. 11 is a diagram illustrating a power management method according to the first variation.

FIG. 12 is a diagram illustrating a power management method according to the first variation.

FIG. 13 is a diagram illustrating a power management method according to the first variation.

### DESCRIPTION OF EMBODIMENTS

Embodiments will be described below with reference to the accompanying drawings. In the following description of the drawings, the same or similar components will be denoted by the same or similar reference signs. However, the drawings are schematic.

### Embodiment

### Power Management System

A power management system according to an embodiment will be described below. The power management system may be simply referred to as a power system.

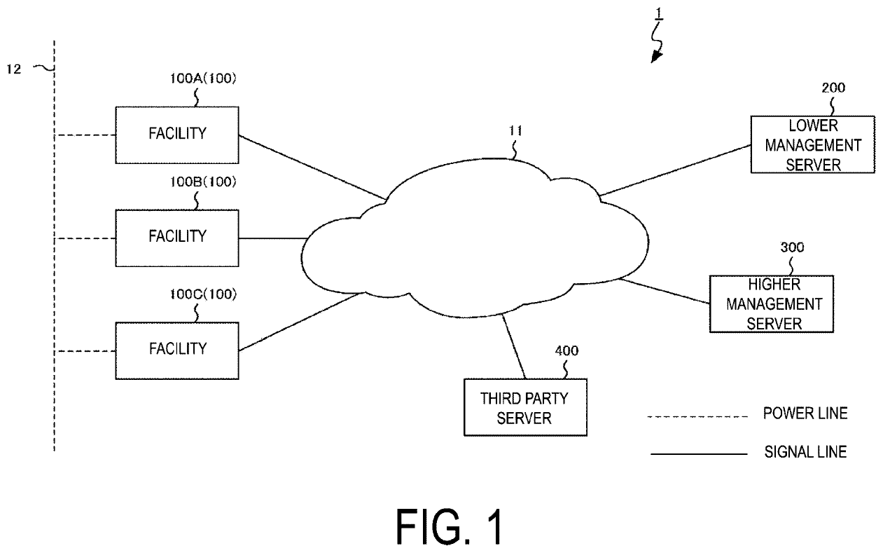

As illustrated in FIG. 1, a power management system 1 includes a facility 100. The power management system 1 includes a lower management server 200, a higher management server 300, and a third party server 400.

Here, the facility 100, the lower management server 200, the higher management server 300, and the third party server 400 are communicable with each other through a network 11. The network 11 may include the Internet, a dedicated line such as a virtual private network (VPN), or a mobile communication network.

The facility 100 is connected to a power system 12, and may be supplied with power from the power system 12 or may supply power to the power system 12. Power from the power system 12 to the facility 100 may be referred to as a forward power flow. Power from the facility 100 to the power system 12 may be referred to as a reverse power flow power.

FIG. 1 illustrates facilities 100A to 100C as examples of the facility 100.

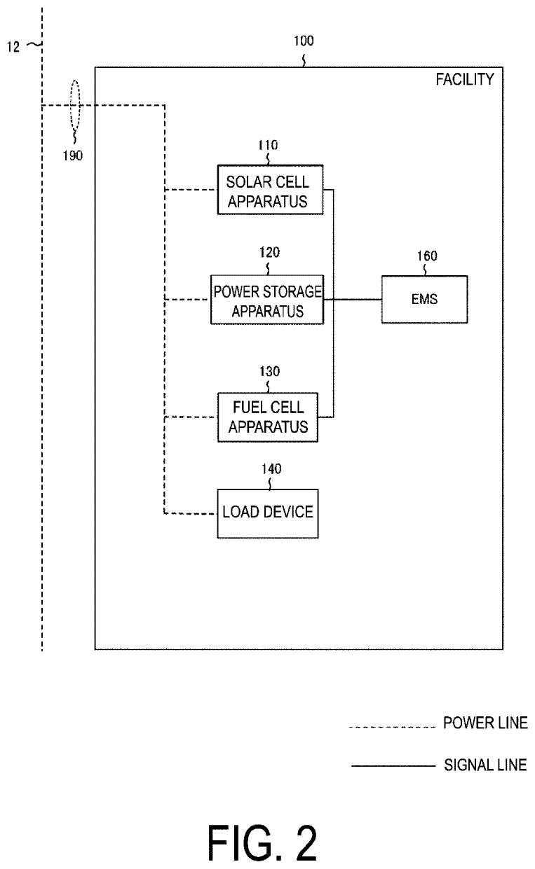

The facility 100 may be and is not particularly limited to a facility such as a residence, a shop, or an office. The facility 100 may be a residential complex including two or more residences. The facility 100 may be a complex facility including at least two facilities of residences, shops, and offices. The details of the facility 100 will be described below (see FIG. 2).

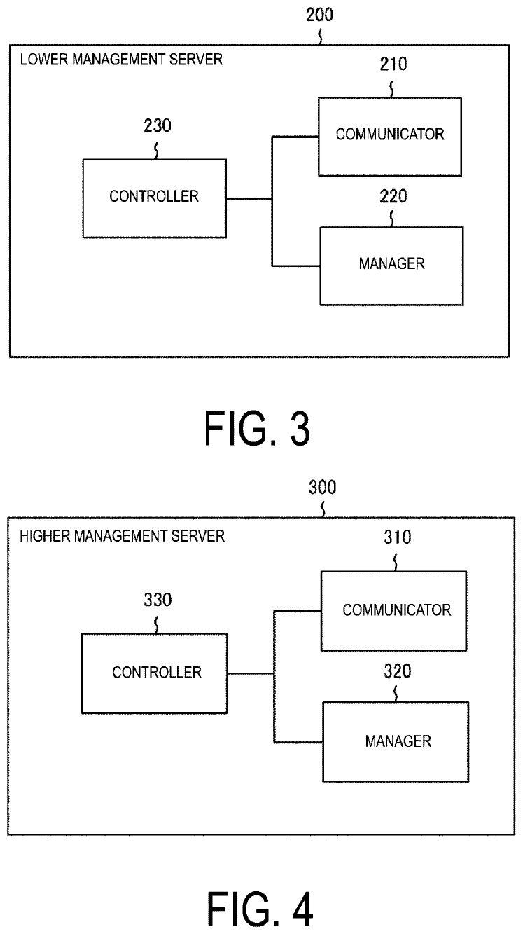

The lower management server 200 is managed by an operator that manages power related to the power system 12. The operator may be a resource aggregator (RA). The operator may be a power generation operator or may be a retailer. The lower management server 200 will be described later in detail (see FIG. 3).

In the embodiment, the lower management server 200 constitutes a power management apparatus that manages two or more facilities 100 (hereinafter, also referred to as a facility group 100).

The higher management server 300 is managed by an operator that manages power related to the power system 12. The higher management server 300 may be managed by an operator that provides services to an operator of the lower management server 200. The higher management server 300 may be also referred to as an area energy management system (AEMS). The operator may be an aggregation coordinator (AC). The service may include a service for suppressing, to a predetermined difference or less, a difference (imbalance) between a planned value for the forward power flow (hereinafter, also referred to as “procured power”) of the facility group 100 and an actual value for the procured power of the facility group 100. The service may also include a service for suppressing, to a predetermined difference or less, a difference (imbalance) between a planned value for the reverse power flow power (hereinafter, also referred to as “generation power”) of the facility group 100 and an actual value for the generation power of the facility group 100. The higher management server 300 will be described later in detail (see FIG. 4).

The third party server 400 is managed by an operator that manages a power supply-demand balance of the power system 12. The operator may manage the capacity market concerning the power system 12. For example, the third party server 400 may have a function of checking an imbalance of the procured power. The third party server 400 may have a function of checking an imbalance of the generation power. For example, the third party server may perform the following operations.

First, the third party server 400 may check whether or not a difference (imbalance) between the planned value for the procured power and an actual value for the procured power exceeds a predetermined difference. The planned value and the actual value may be collected for a unit period (for example, every 30 minutes), and the imbalance may be checked for a unit period (for example, every 30 minutes). The third party server 400 may impose a penalty on an operator managing the lower management server 200 when the imbalance exceeds the predetermined difference. The third party server 400 may provide an incentive to an operator managing the lower management server 200 when the imbalance does not exceed the predetermined difference. The penalty and the incentive may be financially provided.

Second, the third party server 400 may check whether or not a difference (imbalance) between the planned value for the generation power and an actual value of the generation power exceeds a predetermined difference. The planned value and the actual value may be collected for a unit period (for example, every 30 minutes), and the imbalance may be checked for a unit period (for example, every 30 minutes). The third party server 400 may impose a penalty on an operator managing the lower management server 200 when the imbalance exceeds the predetermined difference. The third party server 400 may provide an incentive to an operator managing the lower management server 200 when the imbalance does not exceed the predetermined difference. The penalty and the incentive may be financially provided.

Here, the period during which the imbalance is checked for the generation power and the procured power may be defined as a subject period (for example, one day). In such a case, the planned value for the procured power may include a plan formulated at a time prior to the subject period (for example, 12:00 on the previous day of the subject period). The planned value for the generation power may include a planned value formulated at a time prior to the subject period (for example, 12:00 on the previous day of the subject period). The planned value for the procured power may include a planned value formulated at a time prior to the unit period included in the subject period (for example, one hour prior to the unit period). The planned value for the generation power may include a planned value formulated at a time prior the unit period included in the subject period (for example, one hour prior to the unit period).

Although no particular limitation is intended, the planned value for the procured power and the actual value for the procured power may be reported from the lower management server 200 or the higher management server 300. The planned value for the generation power and the actual value for the generation power may be reported from the lower management server 200 or the higher management server 300.

### Facility

The facility according to the embodiment will be described below. As illustrated in FIG. 2, the facility 100 includes a solar cell apparatus 110, a power storage apparatus 120, a fuel cell apparatus 130, a load unit 140, and an energy management system (EMS) 160. The facility 100 may include a measurement apparatus 190.

The solar cell apparatus 110 is a distributed power supply that generates power in response to sunlight or other light. For example, the solar cell apparatus 110 includes a power conditioning system (PCS) and a solar panel. In this case, being installed may mean that the solar cell apparatus 110 and the power system 12 are connected to each other.

The power storage apparatus 120 is a distributed power supply that charges and discharges power. For example, the power storage apparatus 120 includes a PCS and a power storage cell. In this case, being installed may mean that the power storage apparatus 120 and the power system 12 are connected to each other.

The fuel cell apparatus 130 is a distributed power supply that generates power using a fuel. For example, the fuel cell apparatus 130 includes a PCS and a fuel cell. In this case, being installed may mean that the fuel cell apparatus 130 and the power system 12 are connected to each other.

For example, the fuel cell apparatus 130 may be a solid oxide fuel cell (SOFC), a polymer electrolyte fuel cell (PEFC), a phosphoric acid fuel cell (PAFC), and a molten carbonate fuel cell (MCFC).

The load unit 140 consumes power. For example, the load unit 140 may include an air conditioning apparatus, a heat-pump hot-water supplying unit, and a lighting device.

The EMS 160 manages the power related to the facility 100. The EMS 160 may control the solar cell apparatus 110, the power storage apparatus 120, the fuel cell apparatus 130, and the load unit 140. In the embodiment, the EMS 160 is given as an example of an apparatus that receives a control command from the lower management server 200. Such a device may be referred to as Gateway or may be simply referred to as a controlling unit. The EMS 160 may be referred to as a local EMS (LEMS), a home EMS (HEMS), or a VPP controller so as to be distinguished from the lower management server 200.

The measurement apparatus 190 measures the forward power flow (hereinafter, also referred to as demand power) from the power system 12 to the facility 100. The measurement apparatus 190 may measure the reverse power flow power from the facility 100 to the power system 12. For example, the measurement apparatus 190 may be a Smart Meter that belongs to a power company. The measurement apparatus 190 may transmit an information element indicating a measurement result (an integrated value of the forward power flow or the reverse power flow power) at a first interval (for example, 30 minutes) to the EMS 160 for each first interval. The measurement apparatus 190 may transmit an information element indicating a measurement result at a second interval (e.g., one minute) shorter than the first interval to the EMS 160.

### Lower Management Server

The lower management server according to the embodiment will be described below. As illustrated in FIG. 3, the lower management server 200 includes a communicator 210, a manager 220, and a controller 230.

The communicator 210 includes a communication module. The communication module may be a wireless communication module compliant with standards such as IEEE 802.11a/b/g/n/ac/ax, ZigBee, Wi-SUN, LTE, 5G, and 6G, or may be a wired communication module compliant with standards such as IEEE 802.3.

The communicator 210 may receive facility information on the facility 100. The facility information may include information indicating the configuration of a distributed power supply that the facility 100 includes, and also may include information indicating specifications of the distributed power supply that the facility 100 includes. The facility information may include information (reverse-power-flow availability information) indicating whether or not the facility 100 indicates the reverse power flow. The reverse-power-flow availability information may be information indicating whether or not the facility 100 includes a distributed power supply in which the reverse power flow is permitted. The reverse-power-flow availability information may be referred to as a reverse-power-flow availability flag.

Note that the communicator 210 may receive a planned value for the generation power of each of the facilities 100. The communicator 210 may receive a planned value for the demand power of each of the facilities 100.

The communicator 210 may transmit a control command for controlling an apparatus installed in each of the facilities 100. The apparatus installed in each of the facilities 100 may include a distributed power supply such as the solar cell apparatus 110, the power storage apparatus 120, and the fuel cell apparatus 130. The apparatus installed in each of the facilities 100 may also include the load unit 140.

The manager 220 includes a storage medium such as a hard disk drive (HDD), a solid state drive (SSD), or a non-volatile memory.

In the embodiment, the manager 220 may include a manager that manages two or more facilities 100 connected to the power system 12. The manager 220 may manage information on the facilities 100. For example, the information related to the facilities 100 includes a type of the distributed power supply (the solar cell apparatus 110, the power storage apparatus 120, or the fuel cell apparatus 130) provided at the facility 100, specifications of the distributed power supply (the solar cell apparatus 110, the power storage apparatus 120, or the fuel cell apparatus 130) provided at the facility 100. The specifications may include a rated generated power of the solar cell apparatus 110, a rated charge power of the power storage apparatus 120, a rated discharge power of the power storage apparatus 120, and a rated output power of the fuel cell apparatus 130. The specifications may include a rated capacity and a maximum charge-discharge power of the power storage apparatus 120.

In the embodiment, the manager 220 constitutes a manager that manages the facility group 100.

The controller 230 may include at least one processor. The at least one processor may be constituted by a single integrated circuit (IC) or by a plurality of circuits (such as integrated circuits and/or discrete circuits) connected communicably with each other.

In the embodiment, the controller 230 may constitute a controller that controls a distributed power supply installed in each of the two or more facilities 100. The controller 230 may apply first control to a first distributed power supply installed in a first facility group including one or more facilities in which reverse power flow to the power system 12 is allowed and the reverse power flow is not assumed. The controller 230 may apply second control to a second distributed power supply installed in a second facility group including one or more facilities in which the reverse power flow is allowed and the reverse power flow is assumed.

Here, the first control may be control for autonomously operating the distributed power supply. For example, the controller 230 may set a target demand power to the facility 100, and the distributed power supply may autonomously control the output power of the distributed power supply to bring the demand power of the facility 100 closer to the target demand power. The target demand power may be zero. For example, the first control may be load-following control for controlling the output power of the distributed power supply to follow the power consumption of the facility 100.

The second control may be control in which the controller 230 sequentially operates the distributed power supply. For example, the controller 230 may allocate a target reduced power to each of the facilities 100 to bring the reduced power of the facility group 100 closer to the target reduced power, and may sequentially control the output power of the distributed power supply to achieve the target reduced power based on feed-back of the output power of the distributed power supply. The second control may be referred to as sequential control (or feed-back control) using feed-back from the facility 100. Note that the second control causes a delay error associated with a delay in a control command to the facility 100, feed-back from the facility 100, or the like, compared to the first control.

Here, the target reduced power may be set based on negotiations between the lower management server 200 and the higher management server 300. The target reduced power may be a target of power to be reduced with respect to a base-line power. The reduced power may be power to be reduced with respect to the base-line power. The base-line power may be referred to as a reference value. The base-line power may be an average value of demand power for a certain period of time prior to transmission of an adjustment instruction. This certain period of time may be determined in response to actual negawatt trading, or may be determined between the lower management server 200 and the higher management server 300. The adjustment instruction may include a demand response (DR) request to request a reduction in the forward power flow (procured power).

Under such as premise, the controller 230 may apply the second control to the first distributed power supply when the total allocated reduced-power of the two or more facilities 100 is less than the target reduced power even when the controller 230 applies the first control to the first distributed power supply and applies the second control to the second distributed power supply.

### Higher Management Server

The higher management server according to the embodiment will be described below. As illustrated in FIG. 4, the higher management server 300 includes a communicator 310, a manager 320, and a controller 330.

The communicator 310 includes a communication module. The communication module may be a wireless communication module compliant with standards such as IEEE 802.11a/b/g/n/ac/ax, ZigBee, Wi-SUN, LTE, 5G, and 6G, or may be a wired communication module compliant with standards such as IEEE 802.3.

For example, when a supply-demand balance of the power system 12 needs to be adjusted, the communicator 310 may transmit, to the lower management server 200, an adjustable-power request to inquire about the amount of power that can be adjusted by the facility group 100. As a response to the adjustable-power request, the communicator 310 may receive, from the lower management server 200, an adjustable-power response including the amount of power that can be adjusted by the facility group 100 (hereinafter, referred to as an adjustable amount). The planned value for achieving the adjustable amount may be considered to the corrected planned value described above.

For example, when a supply-demand balance of the power system 12 needs to be adjusted, the communicator 310 may transmit, to the lower management server 200, an adjustment instruction to give an instruction to adjust at least any one of the procured power or the adjusted power. As a response to the adjustment instruction, the communicator 310 may receive, from the lower management server 200, an adjustment result of at least any one of the procured power or the adjusted power.

The manager 320 includes a storage medium such as a hard disk drive (HDD), a solid state drive (SSD), or a non-volatile memory.

For example, the manager 320 may manage the amount of power that can be adjusted by the facility group 100.

The controller 330 may include at least one processor. The at least one processor may be constituted by a single integrated circuit (IC) or by a plurality of circuits (such as integrated circuits and/or discrete circuits) connected communicably with each other.

For example, the controller 330 may instruct the communicator 310 to transmit the adjustment instruction described above, based on the amount of power that can be adjusted by the facility group 100. The adjustment power amount instructed by the adjustment instruction may be the adjustable amount itself, or may be the amount of power allocated up to the adjustable amount. The planned value for achieving the adjustment power amount may be considered to be the corrected planned value described above.

Here, the adjustment instruction may include information indicating the target reduced power described above. In other words, the target reduced power described above may be one example of the adjustment power amount instructed by the adjustment instruction.

### Classification of Facilities

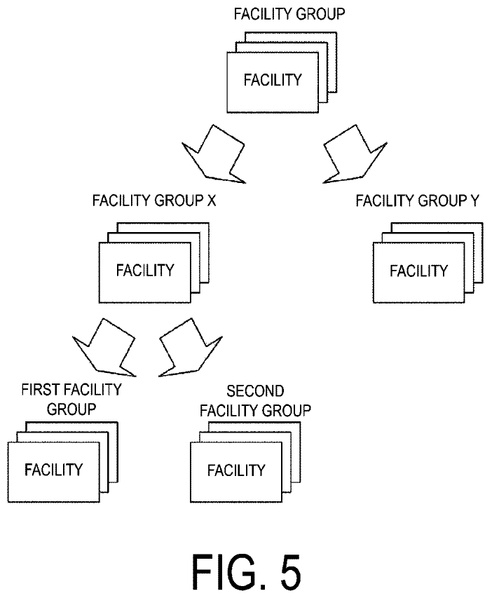

Classification of facilities according to the embodiment will be described below. As illustrated in FIG. 5, a facility that belongs to the group of facilities 100 managed by the lower management server 200 may be classified into a facility group X including one or more facilities in which the reverse power flow is allowed or a third facility group (hereinafter, referred to as a facility group Y) including one or more facilities in which the reverse power flow is not allowed. The facility that belongs to the facility group X may be classified into the first facility group including one or more facilities in which the reverse power flow is not assumed or the second facility group including one or more facilities in which the reverse power flow is assumed.

Here, the facility in which the reverse power flow is allowed may be a facility having a distributed power supply in which the reverse power flow is allowed. The facility in which the reverse power flow is not allowed may be a facility not having any distributed power supply in which the reverse power flow is allowed. The facility in which the reverse power flow is not assumed may be considered to be a facility in which the reverse power flow is not planned, and may be identified based on the planned value for the generation power or the demand power of each of the facilities 100. The facility in which the reverse power flow is assumed may be considered to be a facility in which the reverse power flow is planned, and may be identified based on the planned value for the generation power of each of the facilities 100.

Based on the classification of the facilities 100 as described above, the lower management server 200 applies the following control to the distributed power supply that each of the facilities 100 includes.

First, the lower management server 200 applies the first control to the distributed power supply of the facility 100 that belongs to the facility group Y. For example, the first control may be load-following control for controlling the output power of the distributed power supply to follow the power consumption of the facility 100.

Second, the lower management server 200 applies the first control to the first distributed power supply of the facility 100 that belongs to the first facility group. For example, the first control may include load-following control for controlling the output power of the distributed power supply to follow the power consumption of the facility 100. The first distributed power supply may include the power storage apparatus 120.

Third, the lower management server 200 applies the second control to a second distributed power supply of the facility 100 that belongs to the second facility group. For example, the second control may include sequential control (or feed-back control) that uses feed-back from the facility 100. The second distributed power supply may include the power storage apparatus 120.

Here, the power may be reduced by the first control up to demand power of the facility 100. Meanwhile, as for the facility 100 in which the first control is planned, the reverse power flow is assumed for the power that can be reduced through the second control. Thus, this power is assumed to be larger than the power that can be reduced by the first control. Meanwhile, the second control is control that can cause a delay error associated with a delay of a control command to the facility 100, feed-back from the facility 100, or the like, compared to the first control.

The lower management server 200 may apply the second control to the first distributed power supply when the total allocated reduced-power of two or more facilities 100 is less than the target reduced power even if the lower management server 200 applies the first control to the first distributed power supply installed in the first facility group and also applies the second control to the second distributed power supply installed in the second facility group. In other words, the lower management server 200 changes control applied to the first distributed power supply from the first control to the second control. The lower management server 200 may select the first distributed power supply to which the second control is applied, so as to bring the total allocated reduced-power closer to the target reduced power.

As described above, as for the first distributed power supply of a facility that belongs to the first facility group, while applying the first control in principle, the control applied to the first distributed power supply is changed from the first control to the second control when the total allocated reduced-power is less than the target reduced power. Thus, the power supply-demand balance of the power system 12 can be appropriately maintained while suppressing a delay error.

### Power Management Method

A power management method according to the embodiment will be described below.

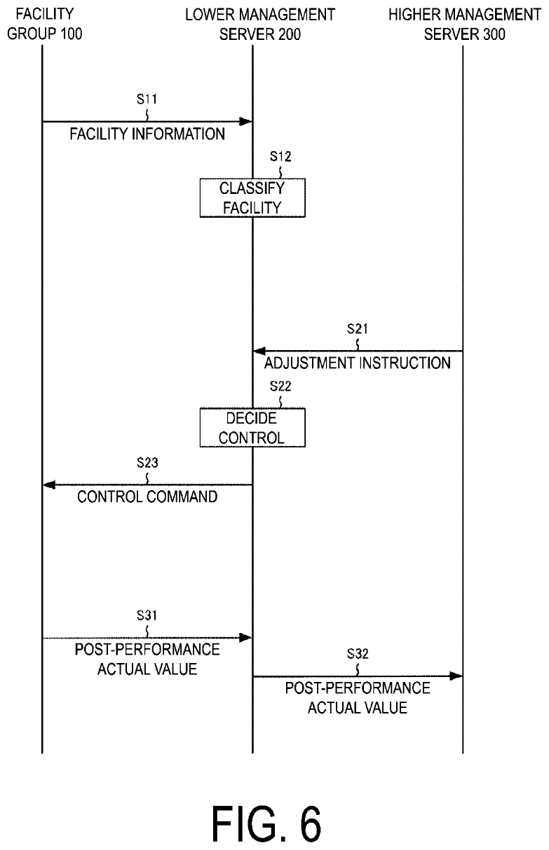

As illustrated in FIG. 6, in step S11, the lower management server 200 receives facility information from the facility 100. The facility information may include information indicating the configuration of a distributed power supply that the facility 100 includes, and also may include information indicating specifications of the distributed power supply that the facility 100 includes. The facility information may include information (reverse-power-flow availability information) indicating whether or not the facility 100 indicates the reverse power flow.

In step S12, the lower management server 200 classifies the facility 100 based on the facility information. The method of classifying the facility 100 has been described above, and thus the details thereof will be omitted.

In step S21, when a supply-demand balance of the power system 12 needs to be adjusted, the higher management server 300 transmits, to the lower management server 200, an adjustment instruction (DR request) to give an instruction to reduce the procured power.

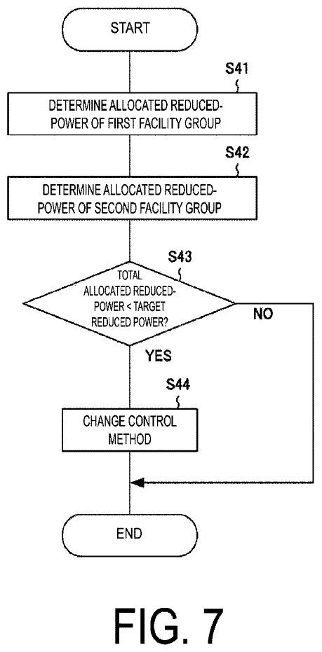

In step S22, the lower management server 200 decides control to be applied to the distributed power supply that the facility 100 includes. Specifically, the lower management server 200 may perform operation illustrated in FIG. 7.

As illustrated in FIG. 7, in step S41, the lower management server 200 determines the allocated reduced-power allocated to each of the facilities 100 in the first facility group on the assumption that the first control is applied to the first distributed power supply installed in the first facility group.

In step S42, the lower management server 200 determines the allocated reduced-power that is allocated to each of the facilities 100 in the second facility group on the assumption that the second control is applied to the second distributed power supply installed in the second facility group.

In step S43, the lower management server 200 determines whether or not the total allocated reduced-power is smaller than the target reduced power. When the total allocated reduced-power is less than the target reduced power, the lower management server 200 performs a process of step S44. When the total allocated reduced-power is equal to or greater than the target reduced power, the lower management server 200 ends the series of processes.

In step S44, the lower management server 200 changes the control to be applied to the first distributed power supply, from the first control to the second control. The lower management server 200 may select the first distributed power supply to which the second control is applied, so as to bring the total allocated reduced-power closer to the target reduced power.

Referring back to FIG. 6, in step S23, the lower management server 200 transmits, to the facility 100, a control command to instruct the control to be applied to the distributed power supply. Note that, although not illustrated in FIG. 6, as for the distributed power supply to which the second control is applied, receiving the feed-back and transmitting the control command are sequentially performed.

In step S31, the facility group 100 transmits a post-performance actual value to the lower management server 200. The post-performance actual value may include an actual value for the generation power of each of the facilities 100, and may include an actual value for the demand power of each of the facilities 100.

In step S32, the lower management server 200 may collect the post-performance actual value of each of the facilities 100 and transmit the post-performance actual value of the facility group 100 to the higher management server 300. The lower management server 200 or the higher management server 300 may transmit the post-performance actual value of the facility group 100 to the third party server 400. The post-performance actual value may include an actual value for the generation power of the facility group 100, and may include an actual value for the procured power of the facility group 100.

### Actions and Effects

In the embodiment, the lower management server 200 applies the first control to the first distributed power supply of the facility 100 that belongs to the first facility group, and applies the second control to the second distributed power supply of the facility 100 that belongs to the second facility group. That is, with the target being set to the facility group X including one or more facilities in which the reverse power flow is allowed, a facility that belongs to the facility group X is classified into the first facility group or the second facility group, and different controls are applied to the first distributed power supply and the second distributed power supply. With such a configuration, by applying different controls to the distributed power supply instead of uniformly treating the facility group X, which includes one or more facilities in which the reverse power flow is allowed, both the suppression of the delay error and the maintenance of the power supply-demand balance are easily achieved.

In the embodiment, the lower management server 200 may apply the second control to the first distributed power supply when the total allocated reduced-power of two or more facilities 100 is less than the target reduced power even if the lower management server 200 applies the first control to the first distributed power supply installed in the first facility group and also applies the second control to the second distributed power supply installed in the second facility group. With such a configuration, as for the first distributed power supply of a facility that belongs to the first facility group, while applying the first control in principle, the control applied to the first distributed power supply is changed from the first control to the second control when the total allocated reduced-power is less than the target reduced power. Thus, the power supply-demand balance of the power system 12 can be appropriately maintained while suppressing a delay error.

For example, a case in which the generation power of the facility group 100 is less than a planned value A, and a case in which the procured power of the facility group 100 is greater than a planned value B, and the like may be considered. A case may be considered in which since the demand power of the facility 100 that belongs to the first facility group is less than the planned power, the allocated reduced-power (the demand power of the facility 100 when the first control is the load-following control, for example) obtained by applying the first control to the first distributed power supply in such a facility 100 is less than the planned power. In these cases, it is assumed that the total allocated reduced-power of two or more facilities 100 is less than the target reduced power even if the first control is applied to the first distributed power supply installed in the first facility group and the second control is applied to the second distributed power supply installed in the second facility group. Thus, the lower management server 200 changes the control applied to the first distributed power supply installed in the first facility group including one or more facilities in which the reverse power flow is assumed, from the first control to the second control, thereby achieving a state in which the reverse power flow from the first facility group can be allowed. With such a configuration, the reverse power flow power of the first facility group can be added to the allocated reduced-power, which makes it possible to increase the total allocated reduced-power and bring the total allocated reduced-power closer to the target reduced power.

### First Variation

A first variation of the embodiment will be described below. The following description will be made mainly of points differing from the embodiment described above.

In the first variation, the communicator 210 of the lower management server 200 may acquire at least any one of the planned value A for the generation power of the facility group 100 or the planned value B for the procured power of the facility group 100.

Here, a period of time in which the imbalance is adjusted for the generation power and the procured power may be defined as a subject period (for example, one day). The imbalance of the generation power and the procured power that is adjusted may be adjusted every unit period (for example, 30 minutes) included in the subject period.

For example, the planned value A may include a plan (hereinafter, referred to as a preliminary planned value A) formulated at a time (for example, 12:00 on the previous day of the subject period) prior to the subject period. The planned value B may include a planned value (hereinafter, referred to as a preliminary planned value B) formulated at a time (for example, 12:00 on the previous day of the subject period) prior to the subject period. The preliminary planned value A and the preliminary planned value B may be collectively referred to as a preliminary planned value.

The planned value A may include a planned value (hereinafter, referred to as a corrected planned value A) formulated at a time prior to the unit period included in the subject period (for example, one hour prior to the unit period). The corrected planned value A may be considered to be a planned value obtained by correcting the preliminary planned value A. The planned value B may include a plan (hereinafter, referred to as a corrected planned value B) formulated at a time prior to the unit period included in the subject period (for example, one hour prior to the unit period). The corrected planned value B may be considered to be a planned value obtained by correcting the preliminary planned value B. The corrected planned value A and the corrected planned value B may be collectively referred to as a corrected planned value.

Although no particular limitation is intended, the preliminary planned value may be determined by collecting preliminary planned values received from each of the facilities 100. The corrected planned value may be formulated (determined) by the controller 230 based on the generation power and the demand power of each of the facilities 100. The corrected planned value may be a planned value indicated by the higher management server 300.

### Problem

A problem according to the first variation will be described below. Specifically, the control for reducing a prediction error in each of the facilities 100 when a prediction error between the planned value and the predicted value occurs will be described. Here, a case in which the predicted value is less than the planned value will be described as an example.

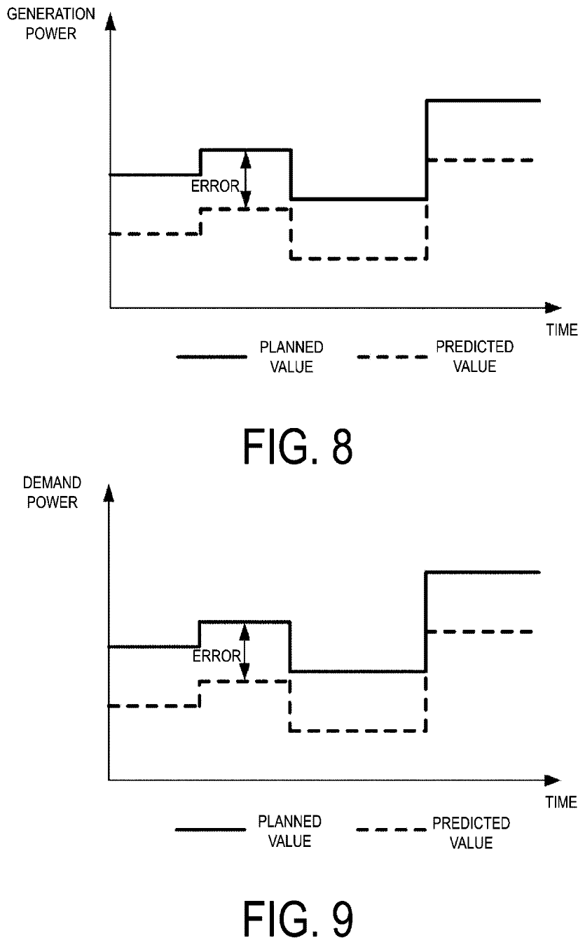

First, as illustrated in FIG. 8, when a difference (prediction error) occurs between the planned value for the generation power of the facility 100 and the predicted value for the generation power of the facility 100, it is assumed to reduce the prediction error by discharging the power storage apparatus 120 installed in the facility 100. That is, since the predicted value of the generation power is less than the planned value for the generation power, it is assumed to achieve an increase in the generation power by discharging the power storage apparatus 120.

Second, as illustrated in FIG. 9, when a difference (prediction error) occurs between the planned value for the demand power of the facility 100 and the predicted value for the demand power of the facility 100, it is assumed to reduce the prediction error by charging the power storage apparatus 120 installed in the facility 100. That is, since the predicted value of the demand power is less than the planned value for the demand power, it is assumed to achieve an increase in the demand power by charging the power storage apparatus 120.

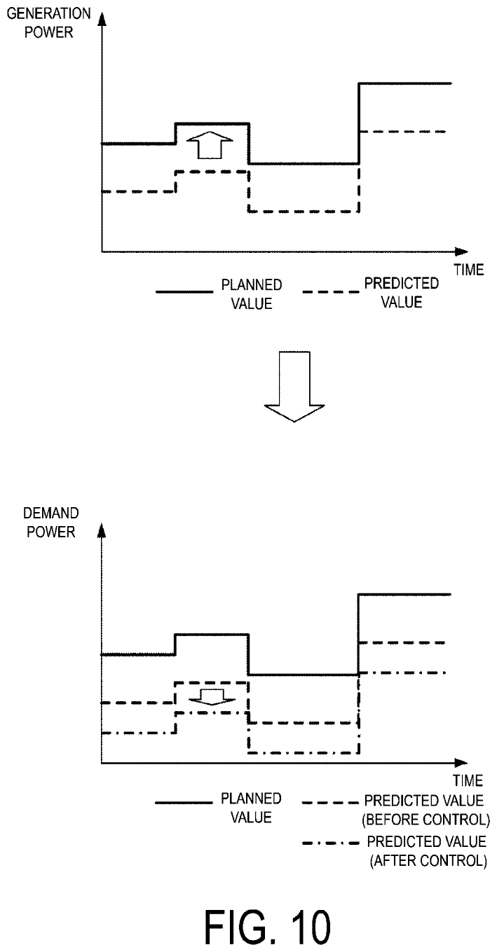

Under such a premise, it is assumed that an increase in the generation power is achieved by causing the power storage apparatus 120 to discharge. For example, when discharge is performed from the power storage apparatus 120 installed in the facility 100 planned to generate the demand power, the discharged power of the power storage apparatus 120 is used for private consumption. Thus, as illustrated in FIG. 10, since the demand power decreases in association with the discharge from the power storage apparatus 120, the imbalance of the demand power (as well as the procured power) may rather increase. In order to solve such a problem, in the first variation, the lower management server 200 performs the operation described below.

### Control A and Control B

Control A and control B according to the first variation will be described below. The controller 230 of the lower management server 200 performs the control A for reducing the prediction error in the planned value A and the control B for reducing the prediction error in the planned value B.

First, of the facility group 100, the controller 230 identifies a facility A that contributes to the generation power. Of the facility group 100, the controller 230 identifies a facility B that contributes to the procured power. That is, the controller 230 classifies each of two or more facilities 100 into the facility A or the facility B.

The following options may be considered as the method of identifying the facility A. In Option 1-1, the controller 230 may identify, as the facility A, a facility planned to generate the generation power. The facility planned to generate the generation power may be a facility assumed to generate the generation power at the preliminary planned value A, or may be a facility assumed to generate the generation power at the corrected planned value A.

In Option 1-2, the controller 230 identifies, as the facility A, a facility that is planned to generate the demand power and that can generate the generation power in association with an increase in the output power of the distributed power supply installed in this facility or a decrease in the demand power of the facility. The facility planned to generate the generation power may be a facility assumed to generate the generation power at the preliminary planned value A, or may be a facility assumed to generate the generation power at the corrected planned value A.

In Option 1-2, the increase in the output power of the distributed power supply may be achieved by discharge from the power storage apparatus 120 installed in the facility 100. The increase in the output power of the distributed power supply may be achieved by increasing the output power of the fuel cell apparatus 130 installed in the facility 100. For example, when the operation mode of the fuel cell apparatus 130 is a load-following mode, the increase in the output power of the fuel cell apparatus 130 may be achieved by changing the operation mode of the fuel cell apparatus 130 into a rated-output mode.

In Option 1-2, the decrease in the demand power of the facility may be achieved by a decrease in the power consumption of the load unit 140 (for example, an air conditioning apparatus, a heat-pump hot-water supplying unit, or a lighting device) installed in the facility 100.

Here, the facility A may be a facility having a configuration of a distributed power supply allowed to output the reverse power flow power. The configuration of the distributed power supply may be a configuration having a distributed power supply (for example, the solar cell apparatus 110) that is allowed to output the reverse power flow power. The distributed power supply allowed to output the reverse power flow power may include the power storage apparatus 120, and may include the fuel cell apparatus 130. The configuration of the distributed power supply may be a configuration with a distributed power supply allowed to have a pushing-up effect of the reverse power flow power derived from a distributed power supply allowed to output the reverse power flow power.

Note that the pushing-up effect is an effect of increasing the output power of a distributed power supply allowed to output the reverse power flow power up to the output power of the distributed power supply allowed to output the reverse power flow power. That is, the distributed power supply allowed to have the pushing-up effect may be a distributed power supply allowed to output the power up to the power consumption of the facility 100.

The following options may be considered for the facility B.

In Option 2-1, the controller 230 identifies, as the facility B, a facility in which the demand power is planned to generate. The facility planned to generate the demand power may be a facility assumed to generate the demand power at the preliminary planned value B, or may be a facility assumed to generate the demand power at the corrected planned value B.

In Option 2-2, the controller 230 identifies, as the facility B, a facility planned to generate the generation power and generate the demand power in association with a decrease in the output power of the distributed power supply installed in this facility or an increase in the demand power of this facility. The facility planned to generate the demand power may be a facility assumed to generate the demand power at the preliminary planned value B, or may be a facility assumed to generate the demand power at the corrected planned value B.

In Option 2-2, the decrease in the output power of the distributed power supply may be achieved by charging the power storage apparatus 120 installed in the facility 100. The decrease in the output power of the distributed power supply may be achieved by a decrease in the output power of the fuel cell apparatus 130 installed in the facility 100. For example, when the operation mode of the fuel cell apparatus 130 is the rated-output mode, the decrease in the output power of the fuel cell apparatus 130 may be achieved by changing the operation mode of the fuel cell apparatus 130 to the load-following mode.

In Option 2-2, the increase in the demand power of a facility may be achieved by increasing the power consumption of the load unit 140 (for example, an air conditioning apparatus, a heat-pump hot-water supplying unit, a lighting device) installed in the facility 100.

Second, in the control A, the controller 230 controls an apparatus A installed in the identified facility A. The apparatus A may include a distributed power supply such as the power storage apparatus 120 and the fuel cell apparatus 130, and may also include the load unit 140 such as an air conditioning apparatus, a heat-pump hot-water supplying unit, or a lighting device. That is, the controller 230 controls the apparatus A to reduce the prediction error in the planned value A.

Here, when Option 2-2 is employed as the method of identifying the facility B, the controller 230 may perform the control A, assuming the generation power that can be decreased by the control B.

Third, in the control B, the controller 230 controls the apparatus B installed in the identified facility B. The apparatus B may include a distributed power supply such as the power storage apparatus 120 and the fuel cell apparatus 130, and may also include the load unit 140 such as an air conditioning apparatus, a heat-pump hot-water supplying unit, or a lighting device. That is, the controller 230 controls the apparatus B to reduce the prediction error in the planned value B.

Here, when Option 1-2 is employed as the method of identifying the facility A, the controller 230 may perform the control B assuming the demand power that can be decreased by the control A.

### Power Management Method

A power management method according to the first variation will be described below.

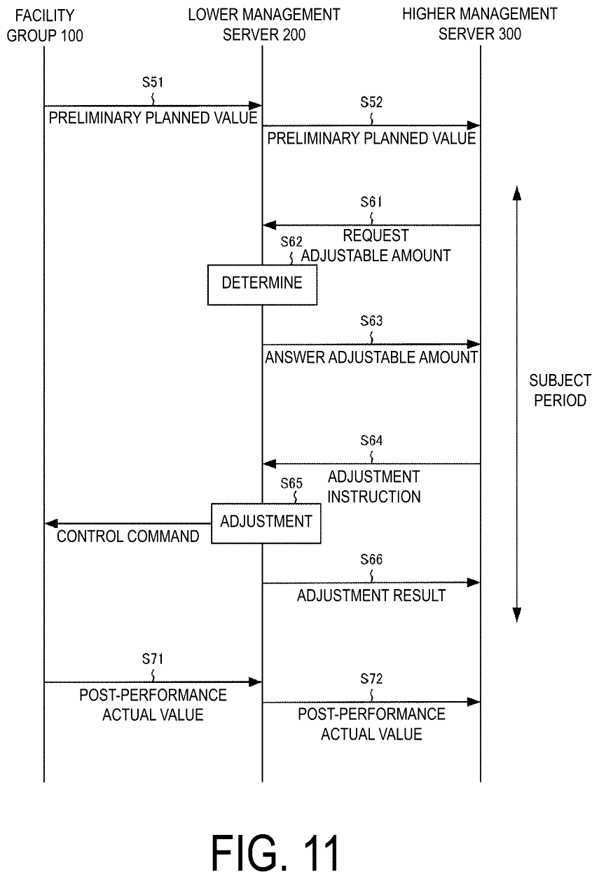

As illustrated in FIG. 11, in step S51, the facility group 100 transmits the preliminary planned value to the lower management server 200. The preliminary planned value may include a planned value for the generation power of each of the facilities 100, and may include a planned value for the demand power of each of the facilities 100.

In step S52, the lower management server 200 may collect planned values of each of the facilities 100 to transmit a preliminary planned value of the facility group 100 to the higher management server 300. The lower management server 200 or the higher management server 300 may transmit the preliminary planned value of the facility group 100 to the third party server 400. The preliminary planned value may include the preliminary planned value A for the generation power of the facility group 100, and may include the preliminary planned value B for the procured power of the facility group 100.

In step S61, when the supply-demand balance of the power system 12 needs to be adjusted, the higher management server 300 transmits, to the lower management server 200, an adjustable-power request to inquire about the amount of power that can be adjusted by the facility group 100.

For example, when the supply-demand balance of the power system 12 needs to be adjusted in a unit period included in the subject period, the higher management server 300 may transmit the adjustable-power request at a time prior to the unit period (for example, one or more hours prior to the unit period).

In step S62, the lower management server 200 identifies the facility A and the facility B. The lower management server 200 identifies the amount of power that can be adjusted by the facility A (hereinafter, referred to as an adjustable amount A) and the amount of power that can be adjusted by the facility B (hereinafter, referred to as an adjustable amount B). The adjustable amount A is the amount of power that can be adjusted in the generation power. The adjustable amount B is the amount of power that can be adjusted in the procured power.

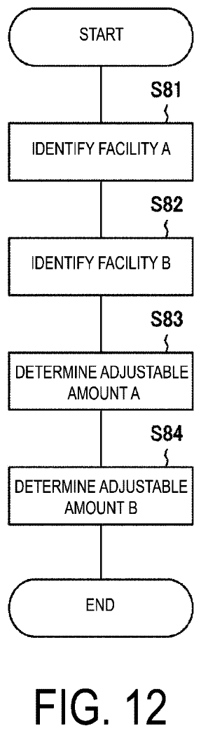

Specifically, in step S81, the lower management server 200 identifies the facility A, as illustrated in FIG. 12. The method of identifying the facility A has been described above, and thus the details thereof will not be omitted.

In step S82, the lower management server 200 identifies the facility B. The method of identifying the facility B has been described above, thus the details thereof will be omitted.

In step S83, the lower management server 200 identifies the adjustable amount A for the facility A. The adjustable amount A is determined based on the chargeable amount or the dischargeable amount of the power storage apparatus 120 disposed in the facility A, the margin of increase or the margin of decrease in the output power of the fuel cell apparatus 130 disposed in the facility A, and the margin of increase or the margin of decrease in the power consumption of the load unit 140 disposed in the facility A.

In step S84, the lower management server 200 determines the adjustable amount B for the facility B. The adjustable amount B is determined based on the chargeable amount or the dischargeable amount of the power storage apparatus 120 disposed in the facility B, the margin of increase or the margin of decrease of the output power of the fuel cell apparatus 130 disposed in the facility B, and the margin of increase or the margin of decrease of the power consumption of the load unit 140 disposed in the facility B.

Referring back to FIG. 11, in step S63, the lower management server 200 transmits an adjustable-power response to the higher management server 300 as a response to the adjustable-power request. The adjustable-power response includes the adjustable amount A and the adjustable amount B.

For example, when the supply-demand balance of the power system 12 needs to be adjusted in the unit period included in the subject period, the lower management server 200 may transmit the adjustable-power response at a time prior to the unit period (for example, one or more hours prior to the unit period).

In step S64, when the supply-demand balance of the power system 12 needs to be adjusted, the higher management server 300 transmits, to the lower management server 200, an adjustment instruction to give an instruction to adjust at least any one of the procured power or the adjusted power.

For example, when the supply-demand balance of the power system 12 needs to be adjusted in the unit period included in the subject period, the higher management server 300 may transmit the adjustment instruction at a time prior to the unit period (for example, one or more hours prior to the unit period). The adjustment instruction may include an adjustment power amount A defined as the adjustable amount A being the upper limit, as the adjustment power amount with respect to the generation power. The adjustment instruction may include an adjustment power amount B defined as the adjustable amount B being the upper limit, as the adjustment power amount with respect to the procured power.

In step S65, the lower management server 200 performs the control A and the control B based on the adjustment instruction. The control A and the control B may be considered to be control performed with the unit period as the smallest unit. For example, the lower management server 200 transmits the control command to the facility group 100.

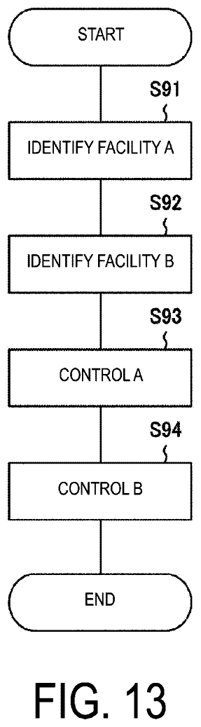

Specifically, in step S91, the lower management server 200 identifies the facility A, as illustrated in FIG. 13. The method of identifying the facility A has been described above, and thus the details thereof will be omitted. Note that, when the facility A has already been identified in step S81 and the facility A does not need to be changed, the process of step S91 may be omitted.

In step S92, the lower management server 200 identifies the facility B. The method of identifying the facility B has been described above, and thus the details thereof will be omitted. Note that, when the facility B has already been identified in step S82 and the facility B does not need to be changed, the process of step S92 may not be performed.

In step S93, the lower management server 200 controls the apparatus A installed in the facility A to reduce the prediction error in the planned value A. As described above, when Option 2-2 is employed as the method of identifying the facility B, the lower management server 200 may perform the control A assuming the generation power that can be decreased by the control B.

Note that, the corrected planned value A for achieving the adjustment power amount A may be used as the planned value A. When the adjustment power amount A is equal to the adjustable amount A, the corrected planned value A for achieving the adjustable amount A may be used as the planned value A.

In step S94, the lower management server 200 controls the apparatus B installed in the facility B to reduce the prediction error in the planned value B. As described above, when Option 1-2 is employed as the method of identifying the facility A, the lower management server 200 may perform the control B assuming the procured power that can be decreased by the control B.

Note that, the corrected planned value B for achieving the adjustment power amount B may be used as the planned value B. When the adjustment power amount B is equal to the adjustable amount B, the corrected planned value B for achieving the adjustable amount B may be used as the planned value B.

Referring back to FIG. 11, in step S66, the lower management server 200 transmits, to the higher management server 300, an adjustment result of at least any one of the procured power or the adjusted power as a response to the adjustment instruction.

In step S71, the facility group 100 transmits a post-performance actual value to the lower management server 200. The post-performance actual value may include an actual value for the generation power of each of the facilities 100, and may include an actual value for the demand power of each of the facilities 100.

In step S72, the lower management server 200 may collect the post-performance actual values of each of the facilities 100 to transmit the post-performance actual values of the facility group 100 to the higher management server 300. The lower management server 200 or the higher management server 300 may transmit the post-performance actual value of the facility group 100 to the third party server 400. The post-performance actual value may include an actual value for the generation power of the facility group 100, and may include an actual value for the procured power of the facility group 100.

Note that, when the embodiment and the first variation are combined together, the lower management server 200 may be considered to perform the following operation.

Specifically, when the reverse power flow power generates by applying the second control to the first distributed power supply, the lower management server 200 may control an apparatus installed in any facility that belongs to the first facility group, assuming the forward power flow decreased by applying the second control.

In such a case, a facility including the first distributed power supply to which the second control changed from the first control is applied may be considered to be a facility planned to generate the demand power, and to be the facility A that can generate the generation power due to an increase in the output power of the distributed power supply installed in the facility or a decrease in the demand power of the facility (Option 1-2 described above). A facility including the first distributed power supply to which the first control is directly applied may be considered to be the facility B planned to generate the demand power (Option 2-1).

For example, a case in which the supply-demand balance of the power system 12 needs to be adjusted and the DR for requesting a reduction in the procured power is issued is considered when the predicted value (or the actual value) for the generation power is lower than the planned value for the generation power. Note that, since the target reduced power is assumed to be set based on the planned values for the generation power and the procured power, when there is no prediction error in the planned value for the generation power and no prediction error in the planned value for the procured power, the total allocated reduced-power can be consistent with the target reduced power.

First, as described in the embodiment, the lower management server 200 applies the first control to the first distributed power supply in the facility 100 that belongs to the first facility group, and applies the second control to the second distributed power supply in the facility 100 that belongs to the second facility group. As described in the embodiment, the lower management server 200 applies the second control to the first distributed power supply when the total allocated reduced-power of two or more facilities 100 is smaller than the target reduced power even if the lower management server 200 applies the first control to the first distributed power supply installed in the first facility group, and also applies the second control to the second distributed power supply installed in the second facility group.

Second, by applying the second control, the lower management server 200 may perform the control A in which the prediction error in the planned value for the generation power is reduced. That is, as the output power of the first distributed power supply increases, the demand power decreases, and the generation power increases. Here, when the control A for reducing the prediction error in the planned value for the generation power is performed, the procured power of the facility group 100 may be excessively decreased.

Third, the lower management server 200 controls an apparatus installed in any facility that belongs to the first facility group, assuming the procured power decreased by applying the second control. Such control is one example of the control B for reducing the prediction error in the planned value for the procured power. For example, for any facility (the facility B planned to generate the demand power) that belongs to the first facility group, the lower management server 200 may decrease the output power of the distributed power supply and may increase the power consumption of the load unit 140. This “any facility that belongs to the first facility group” is a facility including the distributed power supply to which the first control is still being applied.

### Actions and Effects

In the first variation, after classifying two or more facilities 100 into the facility A or the facility B, the lower management server 200 controls the apparatus A installed in the facility A to reduce the prediction error in the planned value A for the generation power, and also controls the apparatus B installed in the facility B to reduce the prediction error in the planned value B for the procured power. The increase in the imbalance of the procured power associated with the control A or the increase in the imbalance of the generation power associated with the control B can be appropriately suppressed.

### Second Variation

A second variation will be described below. The following description will be made mainly of points differing from the first variation described above.

In the first variation described above, the case is mainly described in which the lower management server 200 performs the control (control A) for reducing the imbalance of the generation power and performs the control (control B) for reducing the imbalance of the procured power.

In contrast, in the second variation, the case is described in which the lower management server 200 performs the control (control A) for reducing the imbalance of the generation power without performing the control (control B) for reducing the imbalance of the procured power. Although no particular limitation is intended, the control for reducing the imbalance of the procured power may be performed by the higher management server 300.

In the second variation, the lower management server 200 may be considered to be a server managed by a power generation operator. The higher management server 300 may be considered to be a server that provides one or more retailers with a service.

Under such a background, the facility group 100 managed by the lower management server 200 is assumed to be a portion of a facility group managed by the higher management server 300. Thus, when the lower management server 200 adjusts the imbalance with respect to the generation power of the facility group 100, the procured power of the facility group managed by the higher management server 300 may be affected.

In the second variation, on the assumption of such a problem, when Option 1-2 is employed as the method of identifying the facility A, the lower management server 200 may transmit (report), to the higher management server 300, information on the procured power that may be decreased by the control A. In such a case, the higher management server 300 may be considered as one example of the demand management apparatus.

### Third Variation

A third variation will be described below. The following description will be made mainly of points differing from the first variation described above.

In the first variation described above, the case is mainly described in which the lower management server 200 performs the control (control A) for reducing the imbalance of the generation power and performs the control (control B) for reducing the imbalance of the procured power.

In contrast, in the third variation, the case is described in which the lower management server 200 performs the control (control B) for reducing the imbalance of the procured power without performing the control (control A) for reducing the imbalance of the generation power. Although no particular limitation is intended, the control for reducing the imbalance of the procured power may be performed by the higher management server 300.

In the third variation, the lower management server 200 may be considered to be a server managed by a power retailer. The higher management server 300 may be considered to be a server that provides one or more power generation operators with a service.

Under such a background, the facility group 100 managed by the lower management server 200 is assumed to be a portion of a facility group managed by the higher management server 300. Thus, when the lower management server 200 adjusts the imbalance related to the procured power of the facility group 100, the generation power of the facility group managed by the higher management server 300 may be affected.

In the third variation, on the assumption of such a problem, when Option 2-2 is employed as the method of identifying the facility B, the lower management server 200 may transmit (report), to the higher management server 300, information on the generation power that may be decreased by the control B. In such a case, the higher management server 300 may be considered as one example of the demand management apparatus.

### Other Embodiments

Although the present disclosure is described by the above-described embodiment, it should not be understood that the description and the drawings, which form a part of this disclosure, limit this invention. Various alternative embodiments, examples, and operational techniques will be apparent from this disclosure to those skilled in the art.

The disclosure described above describes, as an example, a case in which the total allocated reduced-power is less than the target reduced power. However, the disclosure described above is not limited to this case. The case in which the total allocated reduced-power is less than the target reduced power may be read as the case in which the total forward power flow is greater than the target forward power flow. The target forward power flow may be power obtained by subtracting the target reduced power from the base-line power.

The disclosure above has described a case in which the total allocated reduced-power is less than the target reduced power even by applying the first control to the first distributed power supply installed in the first facility group and applying the second control to the second distributed power supply installed in the second facility group. However, the disclosure described above is not limited to this case. For example, in a case in which the total allocated reduced-power exceeds the target reduced power even when the first control is applied to the first distributed power supply installed in the first facility group and the second control is applied to the second distributed power supply installed in the second facility group, the lower management server 200 may not change the control applied to the first distributed power supply from the first control.

The disclosure above has described a case in which, assuming that, in principle, the first control is applied to the first distributed power supply installed in the first facility group, the control to be applied to the first distributed power supply is changed to the second control when the total allocated reduced-power is less than the target reduced power. However, the disclosure described above is not limited to this case. For example, a case may be assumed in which the second control is applied, from the beginning, to the first distributed power supply installed in a portion of facilities included in the first facility group.

Although not specifically mentioned in the disclosure above, when the total allocated reduced-power exceeds the target reduced power in a case in which the first control is applied to the distributed power supply that the lower management server 200 can control, the lower management server 200 may apply the first control to one or more distributed power supplies that the lower management server 200 can control, so as to bring the total allocated reduced-power closer to the target reduced power. When the total allocated reduced-power is less than the target reduced power in a case in which the first control is applied to the distributed power supply that the lower management server 200 can control, the lower management server 200 may apply the second control to the second distributed power supply, so as to bring the total allocated reduced-power closer to the target reduced power.

Although not specifically mentioned in the disclosure above, the distributed power supply that the lower management server 200 can control may include the power storage apparatus 120. The first distributed power supply may also be referred to as a first power storage apparatus. The second distributed power supply may also be referred to as a second power storage apparatus. Note that the distributed power supply that the lower management server 200 can control may include a distributed power supply that can control the output power as appropriate. For example, the distributed power supply that the lower management server 200 can control may include the fuel cell apparatus 130, and a power generation unit.

Although not specifically mentioned in the disclosure above, the lower management server 200 and the higher management server 300 may be realized by one server, and the lower management server 200 and the higher management server 300 may be managed by one operator.

Although not specifically mentioned in the disclosure above, the adjustable-power request may be a message that requests any one of the adjustable power for the generation power and the adjustable power for the procured power. The adjustable-power request may include the adjustment power amount (for example, 100 kW) requested from the lower management server 200. The adjustable-power request may include the time of day (for example, YYYYMMDDS) at which adjustment starts.

Although not specifically mentioned in the disclosure above, the adjustable-power response may be a message including any one of the adjustable power for the generation power and the adjustable power for the procured power. When the adjustable power for the generation power is requested, the adjustable-power response may include the adjustable power for the generation power (for example, 60 kW). When the adjustable power for the procured power is requested, the adjustable-power response may include the adjustable power for the procured power (for example, 10 kW). The adjustable-power response may include the time of day (for example, YYYYMMDDS) at which adjustment starts.

Although not specifically mentioned in the disclosure above, the adjustment instruction may be a message that indicates any one of the generation power and the procured power. The adjustment instruction may include the adjustment power amount (for example, 100 kW) to be indicated to the lower management server 200. The adjustment instruction may include the time of day (for example, YYYYMMDDS) at which adjustment starts.

Although not specifically mentioned in the disclosure above, the adjustment result may be a message including any one adjustment result of the generation power and the procured power. When the generation power is adjusted, the adjustment result may include the adjustable power for the generation power (for example, 60 kW). When the procured power is adjusted, the adjustment result may include the adjustable power for the procured power (for example, 10 kW). The adjustment result may include the time of day (for example, YYYYMMDDS) at which the adjustment starts.

Although the term “generation power” is mainly used in the disclosure above, the “generation power” may also be read as “reverse power flow power”.

Although the term “procured power” is mainly used in the disclosure above, the “procured power” may also be read as “forward power flow”. The procured power may be considered to be a term used for the forward power flow of the facility group 100, and the demand power may be considered to be a term used for the forward power flow of each of the facilities 100.

In the disclosure described above, the lower management server 200 performs the first control and the second control so as to bring the total allocated reduced-power closer to the target reduced power. However, the disclosure described above is not limited to this case. The lower management server 200 may perform the first control and the second control so as to bring the total procured power of the group of facilities 100 closer to the target procured power. In such a case, the total procured power of the group of facilities 100 may be considered to be the power assuming that the total allocated reduced-power is reduced from the reference value by the first control and the second control. The target procured power may be considered to be power assuming that the target reduced power is reduced from the reference value. Note that, when the total procured power is greater than the target procured power, the lower management server 200 may change control applied to the first distributed power supply, from the first control to the second control.

Although no particular mention is made in the disclosure above, the power may be expressed as an instantaneous value (W/kW) or may be expressed as an integrated value per unit time (Wh/kWh).

Although no particular mention is made in the disclosure above, it may be possible to provide a program that causes a computer to perform each process that the EMS 160 and the lower management server 200 perform. The program may be recorded in a computer-readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

A chip may be provided that includes a memory that stores a program for executing each process that the EMS 160 and the lower management server 200 perform, and a processor that executes the program stored in the memory.

The above disclosure may have the following problems and effects. Specifically, when the power management apparatus sequentially controls the output power of the distributed power supply, a delay error associated with the sequential control of the distributed power supply, such as a delay error associated with a delay of a control command for controlling the distributed power supply may occur.

As a result of intensive studies, the inventors have found the necessity of maintaining the power supply-demand balance of the power system while suppressing the delay error associated with the sequential control of the distributed power supply.

According to the disclosure described above, the power management apparatus, the power management method, and the program are provided which enables appropriately maintaining the power supply-demand balance of the power system while suppressing a delay error associated with sequential control of the distributed power supply.

### Supplementary Note

The disclosure above may be expressed as follows.

A first feature provides a power management apparatus including: a manager configured to manage two or more facilities connected to a power system; and a controller configured to control a distributed power supply installed in each of the two or more facilities in which the controller applies first control to a first distributed power supply installed in a first facility group including one or more facilities in which reverse power flow to the power system is allowed and the reverse power flow is not assumed, and the controller applies second control to a second distributed power supply installed in a second facility group including one or more facilities in which the reverse power flow is allowed and the reverse power flow is assumed.

In the first feature, a second feature provides a power management apparatus in which the controller applies the second control to the first distributed power supply when a total allocated reduced-power of the two or more facilities is less than a target reduced power even when the first control is applied to the first distributed power supply and the second control is applied to the second distributed power supply.

In the first feature or the second feature, a third feature provides a power management apparatus in which the first control is control to cause the distributed power supply to autonomously operate, and the second control is control to cause the controller to sequentially operate the distributed power supply.

In any one of the first feature to the third feature, a fourth feature provides a power management apparatus in which the controller applies the first control to a third distributed power supply installed in a third facility group including one or more facilities in which the reverse power flow is not allowed.

In the second feature, a fifth feature provides a power management apparatus in which, when reverse power flow power generates by applying the second control to the first distributed power supply, the controller controls an apparatus installed in any facility belonging to the first facility group, assuming forward power flow decreased by applying the second control.

In any one of the first feature to the fifth feature, a sixth feature provides a power management apparatus in which the first distributed power supply includes a power storage apparatus.

A seventh feature provides a power management method including: a step A of managing two or more facilities connected to a power system; and a step B of controlling a distributed power supply installed in each of the two or more facilities, wherein the step B includes the steps of: applying first control to a first distributed power supply installed in a first facility group including one or more facilities in which reverse power flow to the power system is allowed and the reverse power flow is not assumed; and applying second control to a second distributed power supply installed in a second facility group including one or more facilities in which the reverse power flow is allowed and the reverse power flow is assumed.

An eighth feature provides a program that causes a computer to perform: a step A of managing two or more facilities coupled to a power system; and a step B of controlling a distributed power supply installed in each of the two or more facilities, wherein the step B includes the steps of: applying first control to a first distributed power supply installed in a first facility group including one or more facilities in which reverse power flow to the power system is allowed and the reverse power flow is not assumed; and applying second control to a second distributed power supply installed in a second facility group including one or more facilities in which the reverse power flow is allowed and the reverse power flow is assumed.

1. A power management apparatus, comprising:
a manager configured to manage two or more facilities connected to a power system; and
a controller configured to control a distributed power supply installed in each of the two or more facilities, wherein the controller applies first control to a first distributed power supply installed in a first facility group comprising one or more facilities in which reverse power flow to the power system is allowed and the reverse power flow is not assumed, and applies second control to a second distributed power supply installed in a second facility group comprising one or more facilities in which the reverse power flow is allowed and the reverse power flow is assumed.

2. The power management apparatus according to claim 1, wherein the controller applies the second control to the first distributed power supply when a total allocated reduced-power of the two or more facilities is less than a target reduced power even when the first control is applied to the first distributed power supply and the second control is applied to the second distributed power supply.

3. The power management apparatus according to claim 1, wherein
the first control is control to cause the distributed power supply to autonomously operate, and
the second control is control to cause the controller to sequentially operate the distributed power supply.

4. The power management apparatus according to claim 1, wherein
the controller applies the first control to a third distributed power supply installed in a third facility group comprising one or more facilities in which the reverse power flow is not allowed.

5. The power management apparatus according to claim 2, wherein
when reverse power flow power generates by applying the second control to the first distributed power supply, the controller controls an apparatus installed in any facility belonging to the first facility group, assuming forward power flow decreased by applying the second control.

6. The power management apparatus according to claim 1, wherein the first distributed power supply comprises a power storage apparatus.

7. A power management method, comprising:
managing two or more facilities connected to a power system; and
controlling a distributed power supply installed in each of the two or more facilities, wherein
the controlling comprises:
applying first control to a first distributed power supply installed in a first facility group comprising one or more facilities in which reverse power flow to the power system is allowed and the reverse power flow is not assumed; and
applying second control to a second distributed power supply installed in a second facility group comprising one or more facilities in which the reverse power flow is allowed and the reverse power flow is assumed.

8. A program that causes a computer to perform:
managing two or more facilities connected to a power system; and
controlling a distributed power supply installed in each of the two or more facilities, wherein
the controlling comprises:
applying first control to a first distributed power supply installed in a first facility group comprising one or more facilities in which reverse power flow to the power system is allowed and the reverse power flow is not assumed, and
applying second control to a second distributed power supply installed in a second facility group comprising one or more facilities in which the reverse power flow is allowed and the reverse power flow is assumed.
